(19) United States
(12) Patent Application Publication
(10) Pub. No.: US 2014/0097325 A1
(43) Pub. Date: Apr. 10, 2014

(54) PORTABLE ELECTRONIC DEVICE MOUNTING SYSTEM

(71) Applicant: WIMO LABS LLC, Chicago, IL (US)

(72) Inventors: Daniel T. Berg, Antioch, IL (US); Christopher Watson, Highland Park, IL (US); David Brian Seal, Chicago, IL (US); Michael Scum, Chicago, IL (US)

(73) Assignee: WIMO LABS LLC, Chicago, IL (US)

(21) Appl. No.: 13/647,135

(22) Filed: Oct. 8, 2012

(51) Int. Cl. F16M 13/02; F16B 2/10

(52) U.S. Cl. CPC F16M 13/02; F16B 2/10
USPC 248/682; 24/500

(57) ABSTRACT

A system for mounting a portable electronic device may include a mount, a holster, and a clip. The holster may be configured to secure to a portable electronic device and the clip may engage with the holster. The clip may have top and bottom portions. The top clip portion may have a distal end and a mating portion proximate the distal end. The bottom clip portion may have a distal end and a mating portion proximate the distal end. The bottom clip portion, but not the top clip portion may slide through a receiving aperture in the mount.

### CROSS REFERENCE TO RELATED APPLICATIONS

This application is a continuation-in part of and claims priority to U.S. patent application Ser. No. 29/430,831 filed on Aug. 30, 2012, the entirety of which is herein incorporated by reference.

### BACKGROUND OF THE APPLICATION

Bike mounts for mobile phones may be intended for use only on a bike. Previous systems may have a dedicated mount that consist of two components: a clamp and a bracket for holding the electronic device. These systems may be secured to the bike frame and may offer no additional functionality beyond use on a bike. Nor may these systems allow for relatively quick removal of the phone while not riding.

### BRIEF DESCRIPTION OF SEVERAL VIEWS OF THE DRAWINGS

FIG. 1 illustrates a side view of a portable electronic device mounting system, according to techniques of the present application.

FIG. 2 illustrates a perspective view from the top of a holster for a portable electronic device mounting system, according to techniques of the present application.

FIG. 3A provides a perspective view showing the top and bottom portions of a clip for a portable electronic device mounting system, according to techniques of the present application.

FIG. 3B provides a perspective view of the top portion of the clip of FIG. 3A.

FIG. 3C provides a second perspective view of the top portion of the clip of FIG. 3A, taken from a different angle.

FIG. 3D provides a third perspective view of the top portion of the clip of

FIG. 3A, illustrating the bottom of the top portion.

FIG. 4 illustrates an end view of a mount for a portable electronic device mounting system, according to techniques of the present application.

FIGS. 5A-5C illustrate first, second and third section views taken along the centerline of the clip of FIG. 3A and the mount of FIG. 4 as the clip is progressively inserted into the mount, according to techniques of the present application.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION OF THE APPLICATION

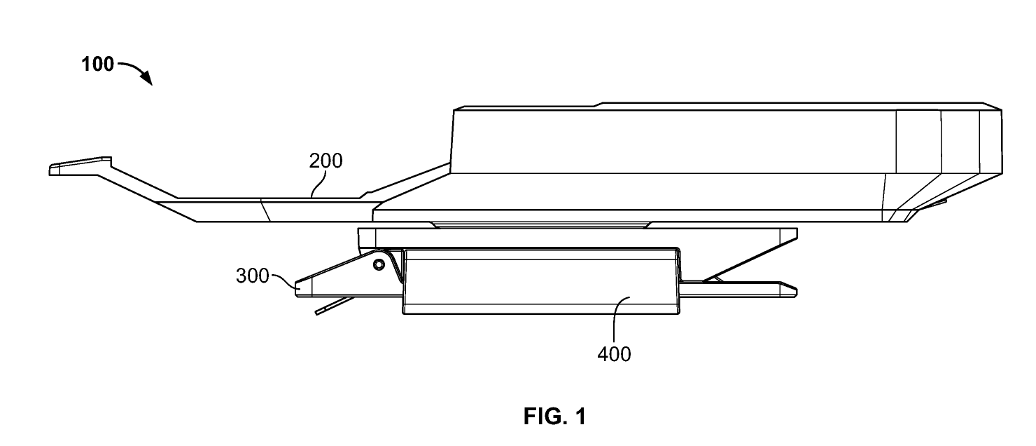

FIG. 1 illustrates a portable electronic device mounting system 100, according to techniques of the present application. The system 100 may include a holster 200, clip 300, and mount 400. The holster 200 may be configured to hold a portable electronic device or a case for a portable electronic device. As will be further described below, the clip 300 may attach or engage with the holster 200 and with the mount 400. In such an arrangement, the clip 300 may cause the portable electronic device to be stabilized with respect to the object that the mount 400 is mounted to (for example, a bicycle or a car dash).

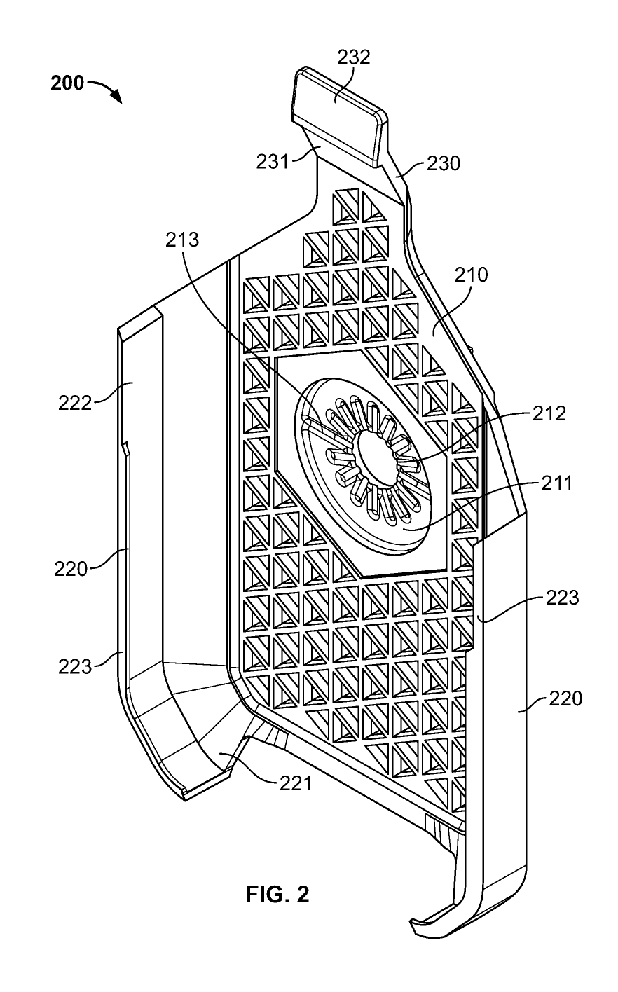

FIG. 2 illustrates a holster 200 for a portable electronic device mounting system, according to techniques of the present application. The holster 200 may be configured to hold or secure to a portable electronic device or a case for a portable electronic device. The holster 200 may include a rear panel 210 including a recessed area 211. The recessed area 211 may include an aperture 212 and detents 213. The rear panel 210 may include a plurality of apertures, such as triangularly shaped apertures. The holster 200 may include one or more sidewalls 220 including risers 222, lips 223, and chamfered regions 221 between the rear panel 210 and the risers 222. The holster 200 may also include an arm 230 including a stopping portion 232 and a chamfered region 231 between the rear panel 210 and the stopping portion 232.

The holster 200 may function as follows. A portable electronic device (or case) may slide along a direction parallel to the rear panel 210. The device may slide within the sidewalls 220. As the device is sliding into the sidewalls 220, the arm 230 may compress. Once the device is fully seated within the sidewalls 220, the arm 230 may decompress. The stopping portion 232 may contain the device and, along with the sidewalls 220, prevent the device from moving along a direction parallel to the rear panel 210. The lips 223 may prevent the device from moving in a direction perpendicular to the rear panel 210.

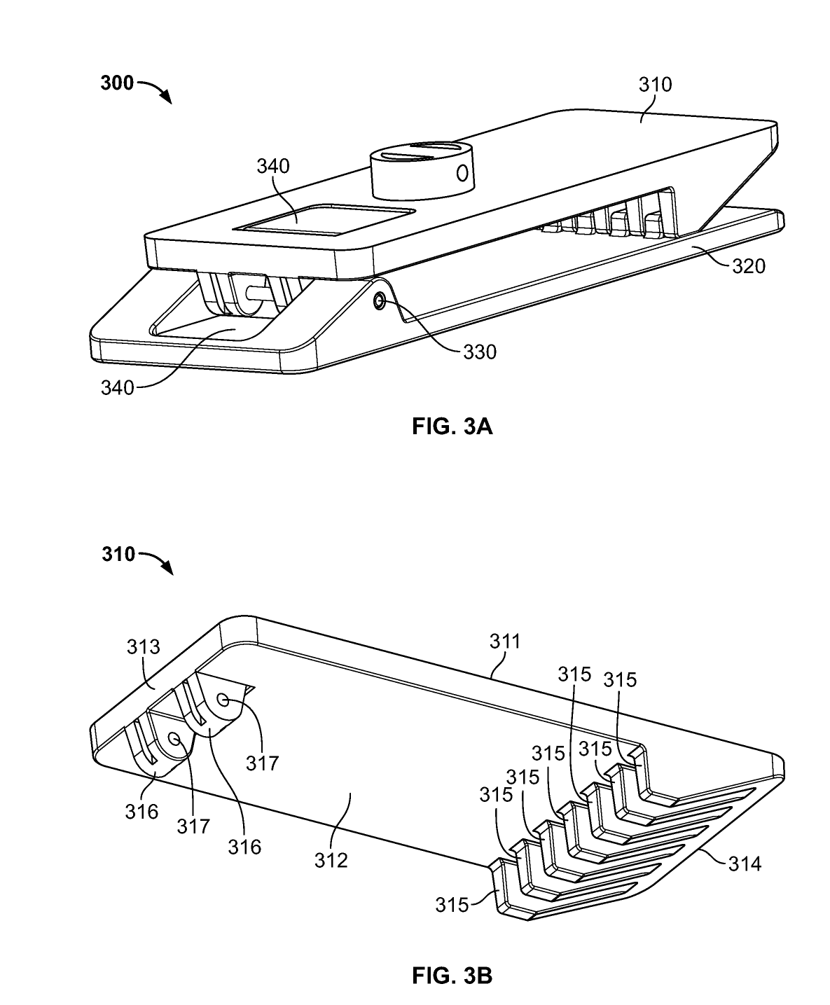

FIGS. 3A-3D illustrate a clip 300 for a portable electronic device mounting system, according to techniques of the present application. As shown in FIG. 3A, the clip 300 may include a top clip portion 310, a bottom clip portion 320, a connection portion 330, and a spring portion 340. As shown in FIGS. 3B and 3C, the top clip portion 310 may include a first side 311 and a second side 312. When engaged with the holster 200, the first side 311 may face towards the holster 200 and the second side 312 may face away from the holster 200 (see FIG. 1). The top clip portion 310 may also include a proximal end 313 and a distal end 314. A top mating portion 315 may be located on the second side 312 and may be proximate the distal end 314.

The top mating portion 315 may include a set of interspersed teeth. The top mating portion 315 may also include a ramp tapered towards the distal end 314 of the top clip portion 310. The ramp may or may not have a constant slope.

One or more connecting portions 316 may be located proximate the proximal end 313 of the top clip portion 310. The connecting portions 316 may include one or more apertures 317. Such apertures 317 may be configured to receive a connection portion (for example, a rod) to facilitate connection with the bottom clip portion 320.

The top clip portion 310 may also include an extension 318 and an aperture 319. The aperture 319 may traverse the extension 318. The extension 318 may insert into the holster aperture 212 (shown in FIG. 2). A rod may be inserted through the aperture 319 after the extension 318 has been inserted into the holster aperture 212. This may allow the top clip portion 310 to be attached to the holster 200. The rod may engage with the holster detents 213 to create a relatively stable arrangement of the top clip portion 210 and the holster 200, while still allowing the top clip portion 210 to be rotated with respect to the holster 200.

As shown in FIG. 3D, the bottom clip portion 320 may include a first side 321 and a second side 322. When engaged with the holster 200, the first side 321 may face towards the top clip portion 310 and the second side 322 may face away from the top clip portion 310 (see FIG. 3A). The bottom clip portion 320 may also include a proximal end 323 and a distal end 324. A bottom mating portion 325 may be located on the first side 321 and may be proximate the distal end 324.

The bottom mating portion 325 may be configured to mate with the top mating portion 315. For example, the bottom mating portion 325 may include a set of interspersed teeth that is complementary to a set of interspersed teeth of the top mating portion 315. The bottom mating portion 325 may also include a ramp tapered towards the distal end 324 of the bottom clip portion 320.

One or more connecting portions 326 may be located proximate the proximal end 323 of the top clip portion 320. The connecting portions 326 may include one or more apertures 327. Such apertures 327 may be configured to receive a rod or other structure to facilitate connection with the top clip portion 310.

The top clip portion 310 and the bottom clip portion 320 may be connected through one or more connecting portions. For example, the top clip portion 310 may have connecting portions 316 and the bottom clip portion 320 may have connecting portions 326. The connecting portions 316, 326 may include apertures 317, 327 respectively. The apertures may align and a rod or other connection portion may be inserted to connect the top and bottom clip portions 310, 320. A spring 340 (an example of which is shown in FIG. 3A) may touch or otherwise be in communication with the top and bottom clip portions 310, 320. For example, the spring 340 may compress when the clip 300 opens and decompress when the clip 300 closes. It may be understood that compression/decompression of the spring 340 may refer to relative levels of compression/decompression. Thus, the spring 340 may still have some amount of compression when the clip 300 is closed.

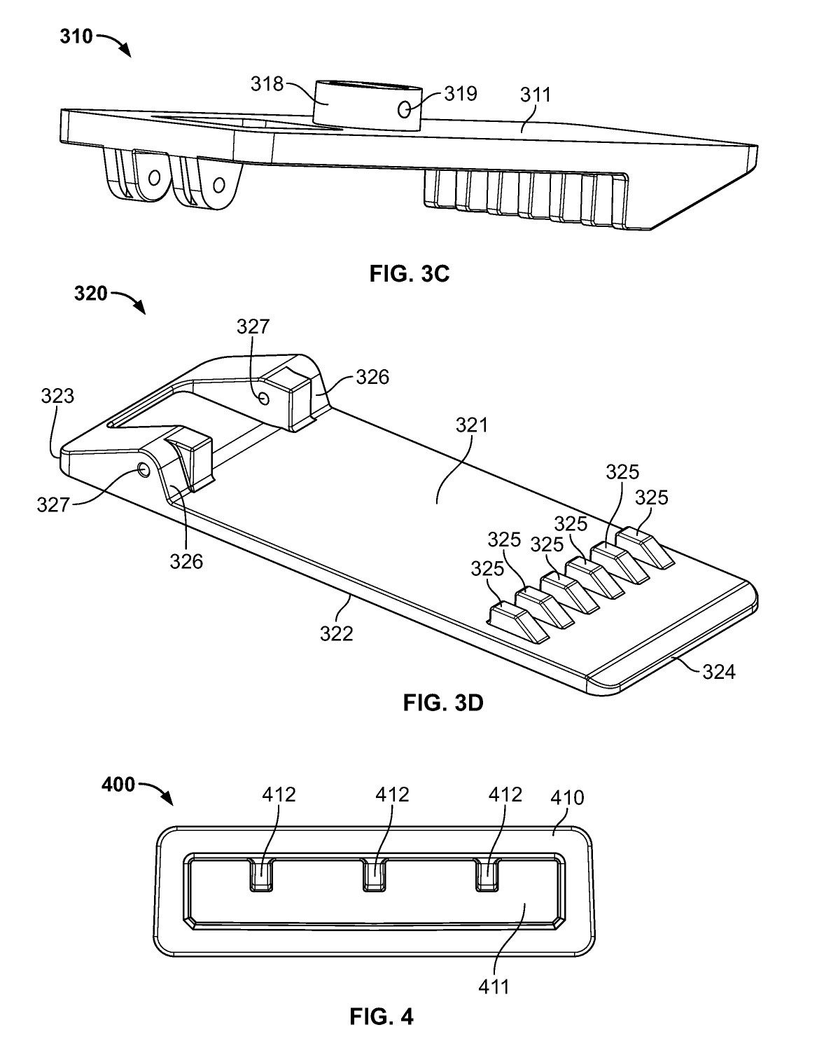

FIG. 4 illustrates a mount 400 for a portable electronic device mounting system, according to techniques of the present application. The mount 400 may include a receiving aperture 411, a receiving portion 410, and portions 412 which form a plurality of grooves in the receiving aperture 411. The receiving aperture 411 may be configured to receive the bottom portion of the clip 320 but not the top portion of the clip 310. The portions 412 may be sized or spaced to receive and pass the bottom mating portion 325 through the receiving aperture 411 of the mount 400.

The mount 400 may be mounted to a vehicle, such as a bicycle. The mount 400 may be mounted to a vehicle by adhesive or through another mechanical portion such as a clamp (not shown). Other mounting techniques may involve suction or fasteners.

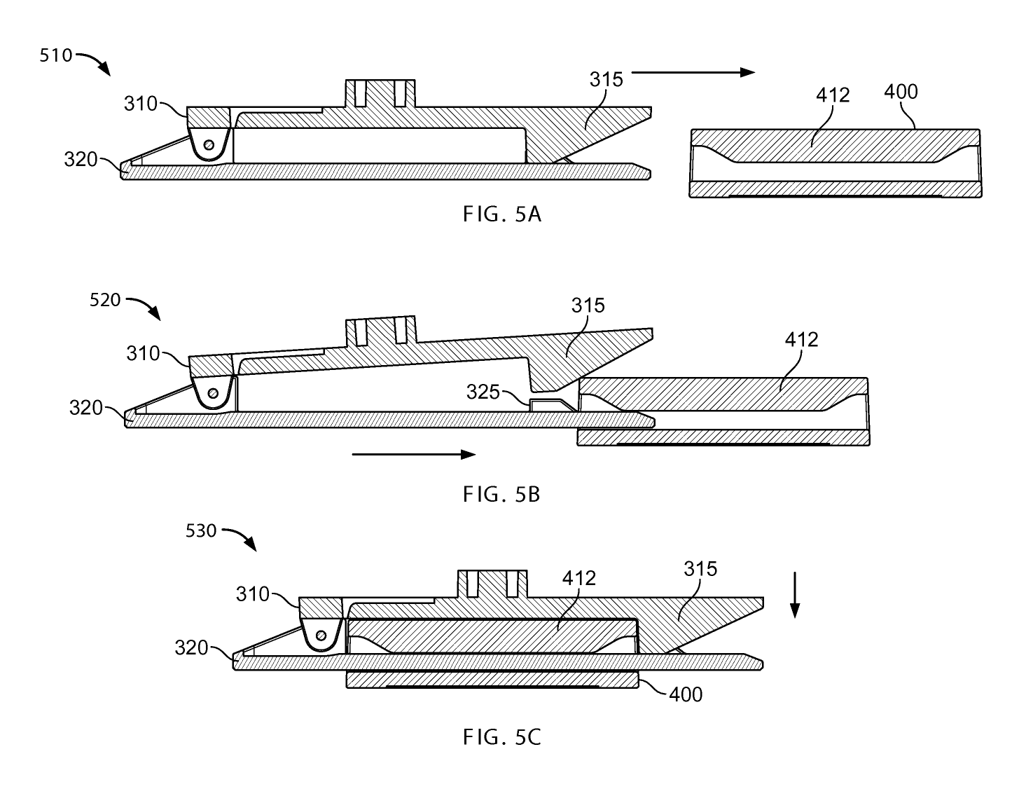

FIG. 5 illustrates a sequence 500 for connecting the clip 300 and mount 400, according to techniques of the present application. At step 510, the clip 300 is directed towards the mount 400. The bottom clip portion 320 is configured to slide through the receiving aperture in the mount 400, while the top clip portion 310 is not.

At step 520, the bottom clip portion 320 begins to be inserted into the receiving aperture in the mount 400. The distal end 314 of the top clip portion 310 is forced away from the distal end 324 of the bottom clip portion 320 as the mount 400 pushes against the top mating portion 315. This may cause the spring 340 to compress. This may also cause the top mating portion 315 to disengage from the bottom mating portion 325. The ramp portion of the top mating portion 315 may facilitate the forcing the distal end 314 of the top clip portion by translating a portion of a laterally applied force into a vertical force.

At step 530, after the top mating portion 315 slides across the top of the mounting portion 400, the spring 340 decompresses and the top mating portion 315 reengages with the bottom mating portion 325.

The bottom clip portion 320 may be stabilized with respect to the mount 400 due to several factors. Lateral movement (left-to-right movement as illustrated in FIG. 5C) may be constrained on one side by the mating portion 315. Lateral movement may be constrained on an opposite side by a portion of the bottom clip portion 320. Vertical movement (up-and-down movement as illustrated in FIG. 5C) may be constrained because the bottom clip portion 320 may be sandwiched between the portions 412 and the bottom portion of the mount 400.

The clip 300 may be dismounted from the mount 400 by lifting the top clip portion 310 upwardly so that the top mating portion 315 no longer constrains the lateral movement of the bottom clip portion 320. The bottom clip portion 320 may then be removed from the mount 400, thereby dismounting the clip 300 from the mount 400.

Thus, the clip 300 may be mounted to and dismounted from the mount 400. When dismounted, the clip 300 may be used as a belt clip, thereby securing the holster 200 (and a portable electronic device held by the holster 200) to a user's belt or other base structure. The top and bottom mating portions 315, 325 may help secure the clip to the base structure. For example, when clipped to a belt, the top and bottom mating portions 315, 325 may prevent against incidental removal.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A system for mounting a portable electronic device, wherein the system comprises:
a mount including a receiving portion defining a receiving aperture;
a holster configured to secure to at least one of a portable electronic device or a case for a portable electronic device and including an engagement aperture;
a clip configured to engage with the holster, wherein the clip includes:
a top clip portion comprising a first side facing towards the holster, a second side facing away from the holster, a proximal end, a distal end, an engagement portion located on the first side and configured to engage with the engagement aperture of the holster, and a top mating portion located on the second side and proximate the distal end;
a bottom clip portion comprising a first side facing towards the top clip portion, a second side facing away from the top clip portion, a proximal end, a distal end, and a bottom mating portion located on the first side and proximate the distal end, wherein the bottom mating portion is configured to mate with the top mating portion;
at least one connecting portion located proximate to the proximal ends of the top clip portion and bottom clip portion, wherein the at least one connecting portion facilitates connection of the top clip portion and the bottom clip portion; and
a spring portion located proximate to the proximal ends of the top clip portion and the bottom clip portion, wherein the spring portion is in communication with the top clip portion and the bottom clip portion; and
wherein:
the top mating portion engages with the bottom mating portion when the spring portion is decompressed;
the top mating portion disengages with the bottom mating portion when the spring portion is compressed;
the bottom mating portion is configured to slide into and through the receiving aperture;
the top clip portion is not configured to slide into the receiving aperture;
the distal end of the top clip portion is forced away from the distal end of the bottom clip portion by the receiving portion as the bottom clip portion slides into the receiving aperture thereby causing the spring portion to be compressed and causing the top mating portion to disengage from the bottom mating portion; and
after the bottom mating portion slides through the receiving aperture, the spring portion decompresses causing the top mating portion to engage with the bottom mating portion.

2. The system of claim 1, wherein the top mating portion and the bottom mating portion comprise complementary sets of interspersed teeth.

3. The system of claim 2, wherein the receiving aperture includes a plurality of grooves configured to receive the interspersed teeth of the bottom clip portion.

4. The system of claim 1, wherein the top mating portion comprises a ramp tapered towards the distal end of the top clip portion.

5. The system of claim 1, wherein the bottom mating portion comprises a ramp tapered towards the distal end of the bottom clip portion.

6. The system of claim 1, wherein:
the top clip portion comprises a hinge portion proximate the proximal end of the top clip portion, wherein the hinge portion of the top clip portion includes a plurality of apertures;
the bottom clip portion comprises a hinge portion proximate the proximal end of the bottom clip portion, wherein the hinge portion of the bottom clip portion includes a plurality of apertures; and
the connecting portion comprises a rod through the plurality of apertures of the hinge portions of the top clip portion and the bottom clip portion.

7. A clip configured to attach to a mount having a receiving portion and a receiving aperture, wherein the clip includes:
a top clip portion comprising a first side, a second side opposite the first side, a proximal end, a distal end, and a top mating portion located on the second side and proximate the distal end;
a bottom clip portion comprising a first side facing towards the top clip portion, a second side facing away from the top clip portion, a proximal end, a distal end, and a bottom mating portion located on the first side and proximate the distal end, wherein the bottom mating portion is configured to mate with the top mating portion;
at least one connecting portion located proximate to the proximal ends of the top clip portion and bottom clip portion, wherein the at least one connecting portion facilitates connection of the top clip portion and the bottom clip portion; and
a spring portion located proximate to the proximal ends of the top clip portion and the bottom clip portion, wherein the spring portion is in communication with the top clip portion and the bottom clip portion; and
wherein:
the top mating portion engages with the bottom mating portion when the spring portion is decompressed;
the top mating portion disengages with the bottom mating portion when the spring portion is compressed;
the bottom mating portion is configured to slide into and through the receiving aperture;
the top clip portion is not configured to slide into the receiving aperture;
the distal end of the top clip portion is forced away from the distal end of the bottom clip portion by the receiving portion as the bottom clip portion slides into the receiving aperture thereby causing the spring portion to be compressed and causing the top mating portion to disengage from the bottom mating portion; and
after the bottom mating portion slides through the receiving aperture, the spring portion decompresses causing the top mating portion to engage with the bottom mating portion.

8. The clip of claim 7, wherein the top mating portion and the bottom mating portion comprise complementary sets of interspersed teeth.

9. The clip of claim 7, wherein the top mating portion comprises a ramp tapered towards the distal end of the top clip portion.

10. The clip of claim 7, wherein the bottom mating portion comprises a ramp tapered towards the distal end of the bottom clip portion.

11. The clip of claim 7, wherein:
the top clip portion comprises a hinge portion proximate the proximal end of the top clip portion, wherein the hinge portion of the top clip portion includes a plurality of apertures;
the bottom clip portion comprises a hinge portion proximate the proximal end of the bottom clip portion, wherein the hinge portion of the bottom clip portion includes a plurality of apertures; and
the connecting portion comprises a rod through the plurality of apertures of the hinge portions of the top clip portion and the bottom clip portion.

12. A clip configured to attach to a mount having a receiving portion and a receiving aperture, wherein the clip includes:
a top clip portion comprising a first side, a second side opposite the first side, a proximal end, a distal end, and a top mating portion means for mating with a bottom mating portion means and located on the second side and proximate the distal end;
a bottom clip portion comprising a first side facing towards the top clip portion, a second side facing away from the top clip portion, a proximal end, a distal end, and the bottom mating portion means for mating with the top mating portion means and located on the first side and proximate the distal end;
at least one connecting portion located proximate to the proximal ends of the top clip portion and bottom clip portion, wherein the at least one connecting portion facilitates connection of the top clip portion and the bottom clip portion; and
a spring portion located proximate to the proximal ends of the top clip portion and the bottom clip portion, wherein the spring portion is in communication with the top clip portion and the bottom clip portion; and
wherein:
the top mating portion means engages with the bottom mating portion means when the spring portion is decompressed;
the top mating portion means disengages with the bottom mating portion means when the spring portion is compressed;
the bottom mating portion means is for sliding into and through the receiving aperture;
the top clip portion means is not for sliding into the receiving aperture;
the distal end of the top clip portion is forced away from the distal end of the bottom clip portion by the receiving portion as the bottom clip portion slides into the receiving aperture thereby causing the spring portion to be compressed and causing the top mating portion means to disengage from the bottom mating portion means; and
after the bottom mating portion means slides through the receiving aperture, the spring portion decompresses causing the top mating portion means to engage with the bottom mating portion means.

13. The clip of claim 12, wherein the top mating portion means and the bottom mating portion means comprise complementary sets of interspersed teeth.

14. The clip of claim 12, wherein the top mating portion means comprises a ramp tapered towards the distal end of the top clip portion.

15. The clip of claim 12, wherein the bottom mating portion means comprises a ramp tapered towards the distal end of the bottom clip portion.
